(19) United States
(12) Patent Application Publication
(10) Pub. No.: US 2012/0191509 A1
(43) Pub. Date: Jul. 26, 2012

(54) SYSTEMS AND METHODS FOR PROCESSING MANAGEMENT DATA AND CONSOLIDATING SOLICITATION E-MAIL

(75) Inventors: Daniel Hillenbrand McMurtrie, Richmond, VA (US); Thomas Michael Daly, III, Henrico, VA (US)

(73) Assignee: Best Response Strategies, LLC

(21) Appl. No.: 13/356,255

(22) Filed: Jan. 23, 2012

Related U.S. Application Data
(60) Provisional application No. 61/435,504, filed on Jan. 24, 2011.

(51) Int. Cl. G06Q 10/06; G06F 15/16

(52) U.S. Cl. 705/7.36; 709/206

(57) ABSTRACT

Systems and methods for providing entities in a value chain of a product or service with an integrated management system associated with an integrated database which collects information from and provides information to various entities in the value chain, including providing offers targeted to the entities in the value chain. Systems and methods are also disclosed for providing consumers with a service to consolidate e-mails.

### RELATED APPLICATIONS

The present application claims priority from U.S. Provisional Patent Application No. 61/435,504, filed Jan. 24, 2011, the entire contents of which are expressly incorporated herein by reference.

### TECHNICAL FIELD

The present disclosure relates to systems and methods for providing entities in a value chain of a product or service with an integrated management system associated with an integrated database which collects information from and provides information to various entities in the value chain.

### BACKGROUND

For any given product or service, the value chain for providing that product or service to consumers typically comprises several parts, which operate largely independently from one another. As an example, a typical value chain for a product may begin with the manufacturer of the product, who sells the product to one or more distributors, who then sell the product to one or more retailers, who finally sell the product to consumers. Value may also be added to the service or product with partnerships between the providers of the products or services and non-profit organizations (NPOs). For example, a retailer may partner with a local NPO. Advertising that partnership may then increase sales to consumers.

Providers of the service or product (the manufacturers, distributors, resellers, and other similar entities) wish to increase sales (and NPOs wish to increase donations), but may lack an efficient and comprehensive system for contacting the other entities in the value chain. For example, although the manufacturer may have contact with the distributor, a manufacturer may not have contact with the resellers and other similar entities. The providers may also be unable to contact the consumer in a targeted way that is meaningful and which results in increased sales.

Furthermore, providers of services or products may include small enterprises, which do not have the resources to conduct extensive market research and advertising campaigns, especially given the multitude of advertising opportunities available. Small enterprises are typically retailers in the value chain, but distributors, manufacturers, and NPOs may also be small enterprises. Given the demands of marketing to consumers, small enterprises may even have difficulty with routine operations such as managing personnel and tracking expenditures.

Additionally, consumers today are becoming more demanding of providers of goods and services. They wish to purchase goods and services which meet their needs without being inundated with offers which do not interest them. Moreover, many consumers have become desensitized to offers which are not targeted to them.

Finally, NPOs are faced with the challenge of trying to reach their target audience in a cost-effective manner as well as providing their donors with opportunities and rewards that encourage donor loyalty and increased giving to the NPO. Moreover, many entities in a supply chain, both providers and consumers, are interested in having additional opportunities to support NPOs.

Accordingly, it is desirable to provide systems and methods to integrate the entities of the value chain; provide targeted marketing research and advertising, as well as other services, to the providers in the value chain; allow consumers to have greater control of the offers they received, thereby increasing loyalty to the provider entities in the value chain; and integrate NPOs into the value chain.

### SUMMARY

A method is disclosed for processing management data, comprising receiving, via a portal, a request to access a management computer system and a selection of a management function. The management function may be, among other things, marketing services, financial services, employee management services, inventory services, offer services, or consumer services. The method further comprises receiving information related to the management function and automatically updating at least one other management function associated with the first management function.

Any of a variety of management functions may be selected, and the method may comprise further steps, as described herein. For example, if the first management function selected is marketing services, the method may further comprise sending an offer to at least one entity in a value chain. The entities in a value chain may include, among other entities, consumers, retailers, distributors, manufacturers, and non-profit organizations (NPOs). The offer may be targeted to the entity.

A management computer system is also disclosed, comprising a memory containing instructions and a processor coupled to the memory for executing the instruction. The instructions, when executed by the processor, allow the system to receive a request, via a portal, to access the system, receive a selection of a management function, receive information related to the first management function, and automatically update at least one other management function associated with the first management function.

The disclosed system is able to allow a variety of management functions to be selected, and the system would be configured to execute further steps. For example, if the first management function selected is marketing services, the system may be further configured to receive a request to send an offer to at least one entity in a value chain and send a request to at least one entity in a value chain.

A method is further disclosed for sharing information among entities of a value chain, comprising receiving information from the entities, storing the information in an integrated database, and transmitting the stored information to the entities according to a rules engine. The information transmitted may be, among other things, an offer.

Additionally, a method for providing an e-mail message consolidation service, comprising receiving information on a preferences of a consumer, creating an alternate e-mail address for the consumer, and receiving, at the alternate e-mail address, from the consumer, at least one solicitation e-mail message received by the consumer from an entity having a list including the consumer's personal e-mail address. The method further comprises unsubscribing the consumer's personal e-mail address from the list, re-subscribing the consumer's alternate e-mail address to the list, and then receiving at least one solicitation e-mail sent to the consumer at the alternate e-mail address. The at least one solicitation e-mail received at the alternate e-mail address is then filtered according to the consumer's preferences, and a consolidated e-mail message containing at least one solicitation from the filtered solicitation e-mail messages is sent to the consumer's personal e-mail address. The consolidated e-mail message may also include solicitations from other sources, and the solicitations from the other sources may also be filtered according to the consumer's preferences.

Various exemplary embodiments consistent with this disclosure are depicted in FIGS. 1-8, attached and described below, and in the following documents, all of which constitute a part of this specification.

### BRIEF DESCRIPTION OF THE DRAWINGS

FIG. 1 is a block diagram illustrating an exemplary integrated management system, consistent with the present disclosure.

FIG. 2 is a block diagram illustrating information and services exchanged between retailers and the integrated management system, consistent with the present disclosure.

FIG. 3 is a block diagram illustrating information and services exchanged between consumers and the integrated management system, consistent with the present disclosure.

FIGS. 4A and 4B are block diagrams illustrating the information and services exchanged between distributors and the integrated management system, consistent with the present disclosure.

FIGS. 5A and 5B are block diagrams illustrating the information and services exchanged between manufacturers and the integrated management system, consistent with the present disclosure.

FIGS. 6A and 6B are block diagrams illustrating the information and services exchanged between NPOs, entities in the value chain, and the integrated management system, consistent with the present disclosure.

FIG. 7 is a block diagram illustrating the e-mail consolidation function of the system consistent with the present disclosure.

FIG. 8 is a block diagram illustrating an exemplary computer system suitable for implementing embodiments consistent with the present disclosure.

### DETAILED DESCRIPTION

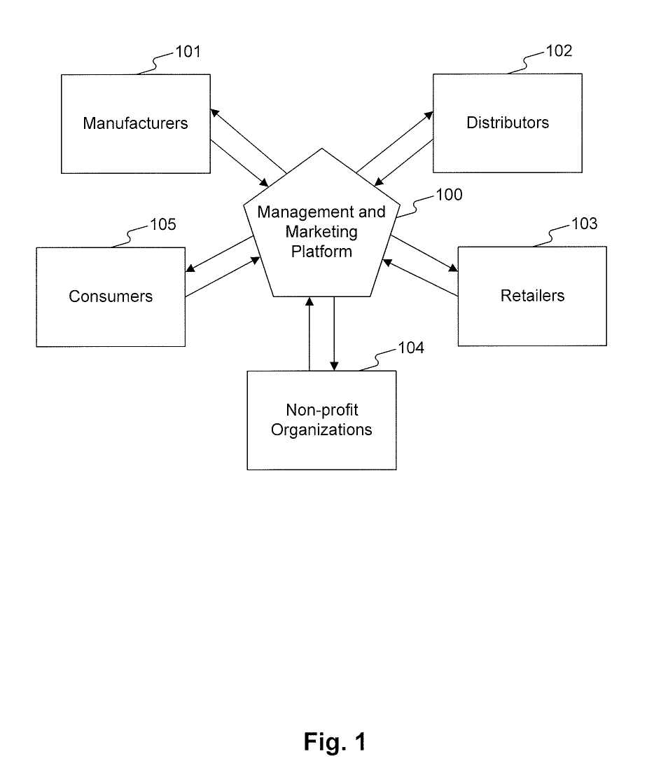

In the drawings, FIG. 1 is a block diagram consistent with embodiments of the present disclosure. An integrated database in a management and marketing platform 100 allows for the flow of information between all entities in an industry's value-added chain, including, for example, manufacturers 101, distributors 102, retailers 103, non-profit organizations 104, and consumers 105.

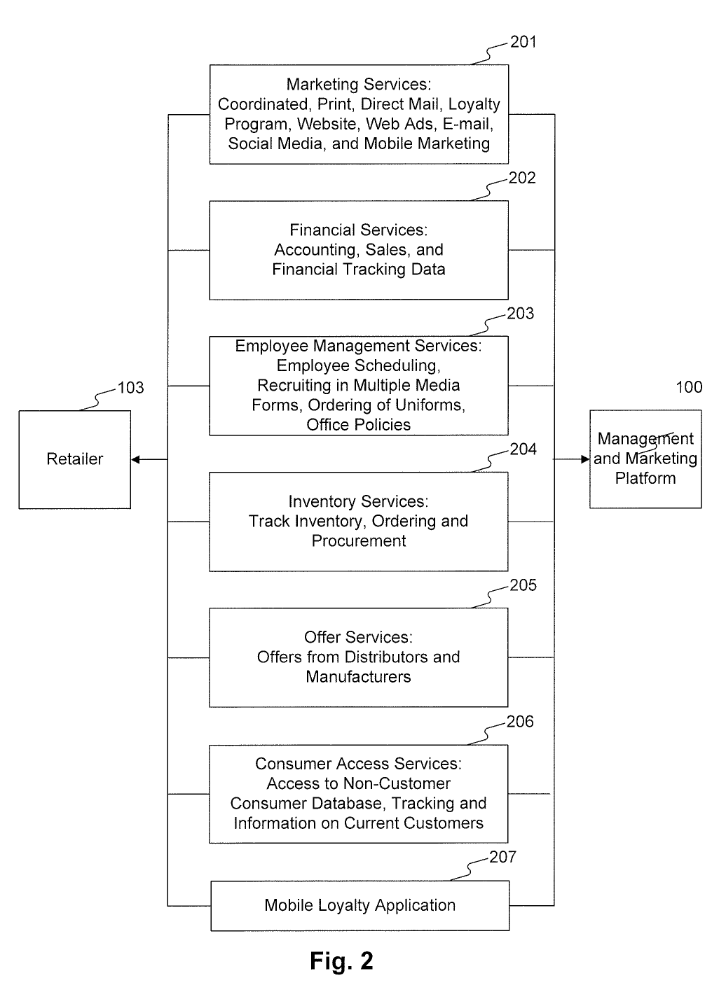

FIG. 2 is a block diagram showing the exchange of information and services between a retailer 103, and the marketing and management platform 100, consistent with embodiments of the present disclosure. One aspect is its appeal to small enterprise owners because of its ease of use. Currently, small enterprise owners can be overwhelmed with the demands of running their businesses. For example, in marketing, a small enterprise owner may have a mobile strategy, a loyalty strategy, a print strategy, direct mail campaigns, a website to maintain, web ads, email campaigns, and a social media strategy. All of these require management time to set up and maintain, as they often change at an accelerated rate. Where formerly a small enterprise owner could merely buy radio or TV ads, now there are many other media to maintain and data to collect from all of them. Operators of businesses may feel challenged to do all of that in addition to the other aspects of running their businesses, such as scheduling employees, training, accounting, online ordering, tracking customer reservations, etc. Thus, there is provided an integrated management system that is linked to an integrated database. The system allows for automation of many management and advertising functions while still allowing the small enterprise owner to customize the system to fit his or her needs.

The system may include marketing services 201, which can provide a retailer 103 with coordinated print, direct mail, loyalty program, website, web ads, email, social media, and mobile marketing. For example, a small enterprise owner may be automatically prompted by the system, in particular, by the offer suggestion tool described below, to send out a promotion to consumers based on such variables as the consumers' purchase propensity, local events, preferences, the weather, etc. The prompt allows the small enterprise owner to choose from several options, e.g., Option 1: allow an unlimited number of promotions to be posted to social media websites and through emails; Option 2: post the promotion to social media websites, through email, and to the small business' website; Option 3: send promotions only to mobile phones via text messages. As another example, the system can track promotions, in particular, by the offer tracking tool described below, on a marketing calendar which shows when the promotions are running or are planned to be run. The marketing calendar can also show the dates and times of holidays and local events. The system can also include a deals library as a repository of previously used promotions, as well as promotions suggested by the system such as promotions that have been previously suggested for that entity or a similar entity, promotions based on geography, promotions suitable for certain types of entities, etc.

The system can further include tools that allow the small business enterprise to profile its own customer base as well as the potential customer base of consumers who use the system. Through this targeting, offers can be pushed those consumers which the small business enterprise believes are most likely to become customers. The offers can be direct (such as a coupon sent to a consumer), or can take many forms, including, among other things, group deals (where the deal is only offered if enough individuals are interested or agree to purchase the offer), sweepstakes (where the winners are selected at random from among the entrants, and contests (where winners are selected by popular vote or judging). The offer suggestion tool, offer tracking tool, and profiling of entities are described below.

In certain embodiments, the marketing services 201 includes a offer suggestion tool for suggesting offers for a small business entity to push to customers or non-customer consumers. The offer suggestion tool uses rules engine and data from the integrated database of the marketing and management platform, including information from the provider entities and consumers, to prompt a small business entity to send targeted offer. Any entity in the value chain can use the offer suggestion tool—a manufacturer may be prompted to send offers to distributors, retailers, consumers, or be prompted to partner with an NPO; a distributer can be prompted to send offers to retailers or consumers, or be prompted to partner with an NPO; etc. It would be apparent to those skilled in the art how the offer suggestion tool could be used by each entity.

The prompt from the offer suggestion tool may be a message to the small business entity owner and the small business entity owner may request that the message be sent according to his preferences as to format (e.g., text message, telephone call from the marketing and management platform customer service center, e-mail, etc.), time (e.g., 8:00 am, Monday afternoons, once per week etc.), or circumstances under which the message is sent (e.g., suggest an offer when there is no other offer available, the day before each local baseball game, when rain is predicted, etc.). Alternatively, the small business entity owner may log into the marketing and management database to request an offer suggestion from the offer suggestion tool.

The integrated database, which is used to formulate the targeted offers, may include, for example, among other things, data on (1) local events, (2) the preferences of consumers (e.g., such as preferring to receive text messages), (3) past purchasing information of consumers in the area, (4) biographical information of consumers, and (5) the history of offers of the small business entity. Then, using the rules engine, the offer suggesting tool can send a message to a bar owner suggesting that he push an offer for a free beer (1) the night of the local baseball game, (2) via text message or e-mail, depending on the preference of the consumer, (3) to the consumers in the area that have purchased a ticket to the baseball game, (4) and who are 21 years or older, (5) if the bar does not have any other offers scheduled for the night of the baseball game. And, if the bar does have an offer scheduled for the night of the baseball game, such as free nachos with any purchase, the offer suggestion tool may suggesting sending the free nachos to all consumers who purchased a baseball ticket instead of the free beer offer to those over 21 years old.

Furthermore, the database and rules engine can be programmed to incorporate data from many sources in addition to the data captured and entered by entities in the value chain. For example, among other things, the system can incorporate information on weather reports and geolocation of the customers of an entity, and, if it is a rainy and cold day, the offer suggestion tool may suggest offering discounts on hot soup to the customers of the restaurant who are within a one-mile radius of the restaurant.

The offers sent to consumers are also tracked by the tracking tool of the marketing and management platform, and information about the response to the offer of the consumer is also tracked and stored in the integrated database. Such response data may include whether the consumer redeemed the offer, viewed the offer, or forwarded the offer, how long the consumer viewed the offer, how many other entities the offer was forwarded to, etc. This data can be used to create even inferences into consumer preferences. For example, the marketing and management platform can use a rules engine to infer which entities prefer text messages to e-mails by comparing the number of times an offer sent by text message is opened compared to the number of times an offer sent by e-mail is opened. A myriad of inferences can be made on the preferences of consumers, including, but not limited to, the media they prefer to receive their offers, the time of day they prefer receiving offers, the type of products or services they prefer receiving offers for, the type of offer they are likely to respond to (e.g., percentage discounts, free offers, 2-for-1 deals, etc.).

In certain embodiments, the rules engine may be programmed to allow an entity's stated preferences to overrule any inferred preference. For example, the rules engine may infer that a consumer is more responsive to text message offers because text messages are always opened, but the consumer may explicitly request that he not receive any offers by text message. Furthermore, the marketing and management system may be programmed to send surveys to entities to gain more information about the entities' preferences.

With the information in the integrated database, including the data from the offer tracking tool, the marketing and management platform creates a profile of each entity in the value chain, including consumers. That is, the data from the offer tracking tool, stated preferences, purchasing history/point-of-sale monitoring (for purchases not associated with particular offers), and other biographical information about each entity are stored in that entity's profile. Using the profiles of the entities, as well as the other information stored in the database, the offer suggestion tool is able create personalized offers to suggest to the entity. The more the various entities use the marketing and management platform, the better the marketing and management platform may become at predicting the offers most likely to be successful. Additionally, as entities are able to provide their customers with the offers that they want, they influence the behavior of their customers and build customer loyalty. This allows small enterprises, or even large enterprises, to advertise much like very sophisticated companies, all through a single access portal.

Furthermore, the single access portal can be a communications medium with which the small enterprise owner is comfortable. For example, the small enterprise owner can access the data from either through a website dashboard or by calling a customer service center. Unlike other offerings, the system integrates multiple functions into a single access portal, simplifying the operation of a small enterprise.

The marketing and management platform 100 may also provide a small enterprise with financial services 202, which may include accounting services, sales and financial tracking data, and payroll. One of skill in the art would understand the accounting services, sales and financial data, and payroll services that would be recorded and used by small enterprises or other entities in the value chain. For example, a small enterprise may record and use profit-and-loss statements, sales and labor ledgers, financial spreadsheets, employee payment records, and tax information such as capital purchases and depreciation schedules, among other things.

The marketing and management platform 100 may also provide a small enterprise with employee management services 203, which may include such services as an employee scheduling tool, recruiting in multiple media forms, easy access to uniform ordering, and a central place to store and post office policies, among other things.

The employee management services 203 may include, for example, an employee scheduling tool that a small enterprise owner can use to create work schedules and then post the schedule for all of its employees. The small enterprise owner can also notify its employees of a new schedule or a change in the schedule via the marketing and management platform 100. The notification can be pushed to the employees using text messaging or e-mail, similar to the way an offer is pushed to customers. Employees can also be granted access to features of the marketing and management platform 100 which would allow them to ask fellow employees for schedule switches or similar, typically work-related, requests. Additional features of a scheduling tool (such as the ability to record and automatically accommodate employees' requests, the ability to track accumulated vacation days, etc.) would be known to one of skill in the art.

The recruiting services of the marketing and management platform 100 may provide a small enterprise owner a single form for describing an open position, and that information can automatically be incorporated into website, web ad, email, social media, and mobile advertisements for the position.

The uniform ordering function may provide the small enterprise owner with the ability to order uniforms from a vendor, for example, the small enterprise's preferred vendor.

The marketing and management platform 100 may also provide the small enterprise with a centralized learning center for employees. The employee learning center may to electronically store such materials as training videos and documents, employee agreements, and office policies. The rules engine may also provide varying access to these documents so that each employee has access only to the materials appropriate to his or her position.

In certain embodiments, the employee management services of the management and marketing platform 100 allows the small enterprise owner to create an internal website for employees. Typically, the internal website would contain information confidential to the business, and the management and marketing platform 100 would provide passwords and tracking of employee access to the posted content. Through the internal website, employees may be granted access to various features of the management and marketing platform, which would allow them to, among other things, check their schedules, modify their schedules, request vacation or other altered schedules, contact other employees, order uniforms, and review office policies and rules, and electronically confirm (either actively or passively) that office policies and rules have been reviewed.

The management and marketing platform 100 may also provide a small enterprise owner with inventory services 204, such as the ability to order inventory and track its use. Because the management and marketing platform 100 interconnects retailers 103, distributors 102, and manufacturers 101, retailers 103 are able to order inventory from distributors 102 and manufacturers 101 through the management and marketing platform 100. Likewise, distributors 102 are able to order inventory from manufacturers 101 through the management and marketing platform 100. Furthermore, in addition to the manufacturer's 101 ability to actively push offers to distributors 102 and retailers 103 via the management and marketing platform's 101 many advertising options, manufacturers 101 may also more passively provide their offers to distributors 102 and retailers 103 via the inventory ordering tool (similarly, distributors may provide their offers to retailers via the inventory ordering tool as well). That is, when a retailer is ordering inventory through the inventory ordering tool, the retailer may be alerted to specials or rebates associated with the products they are purchasing.

Furthermore, small enterprise owners may wish to track inventory using the management and marketing platform 100. Inventory usage may, for example, be entered by the small enterprise owner or the system can estimate inventory levels based on sales data tracked by the system. The system may also automatically reorder inventory, either at pre-determined times or intervals entered by the small enterprise owner, or when inventory levels drop to the level predetermined by the small enterprise owner.

The system may also provide offer services 205, which may provide the retailer 103 with offers from distributors 102 and manufacturers 101. For example, a distributor 102 or manufacturer 101 can push offers to alert the retailer 103 of a sale on certain products. These offers can be pushed in a variety of ways, including via direct mail, advertising on the management and marketing platform user interface, e-mails to the retailer 103, and mobile marketing such as text messages. Of course, the marketing and management platform 100 may also provide the contact information of retailers of a distributor 102 or manufacturer 101, so the distributor or manufacturer may also contact the retailer directly. Furthermore, because distributors 102 and manufacturers 101 may have different levels of access to the data of the retailer 103 stored on the management and marketing platform 100, the distributors 102 and manufacturers 101 can tailor their offers to the needs of the retailer 103. For example, a distributor 102 may be able to track the sales of the retailer 103 of one product and provide a sale or incentive for the retailer 103 to purchase a complimentary product from the distributor 102 to sell to the consumer 105. The offer suggestion tool, described above, may also be used by a distributor or manufacturer to suggest offers that target the retailers.

Retailers 103 may also use the marketing and management platform 100 to communicate with distributors 102 and manufacturers 101 to indicate the 103 preferred method of communication for a retailer 103 (e.g., a preference for e-mail).

In certain embodiments, when a manufacturer, distributor, or retailer sends an offer to another entity in the value chain, the individual sales representatives of the manufacturer, distributor, or retailer, respectively, are also sent copies of the offers so that the sales force is automatically notified of the offers available to their respective customers.

Additionally, the system may also provide small enterprises with access to consumer access services 206, which may include access to a consumer database which may include lists of the small enterprise's customers as well as non-customers. The consumer access services 206 may also include tools for storing, analyzing, and tracking data on current customers and non-customer consumers. The consumer database may include customers from many small enterprises who access the integrated management system, and in this way, small enterprises are able to pool their resources in order to have access to a larger consumer database.

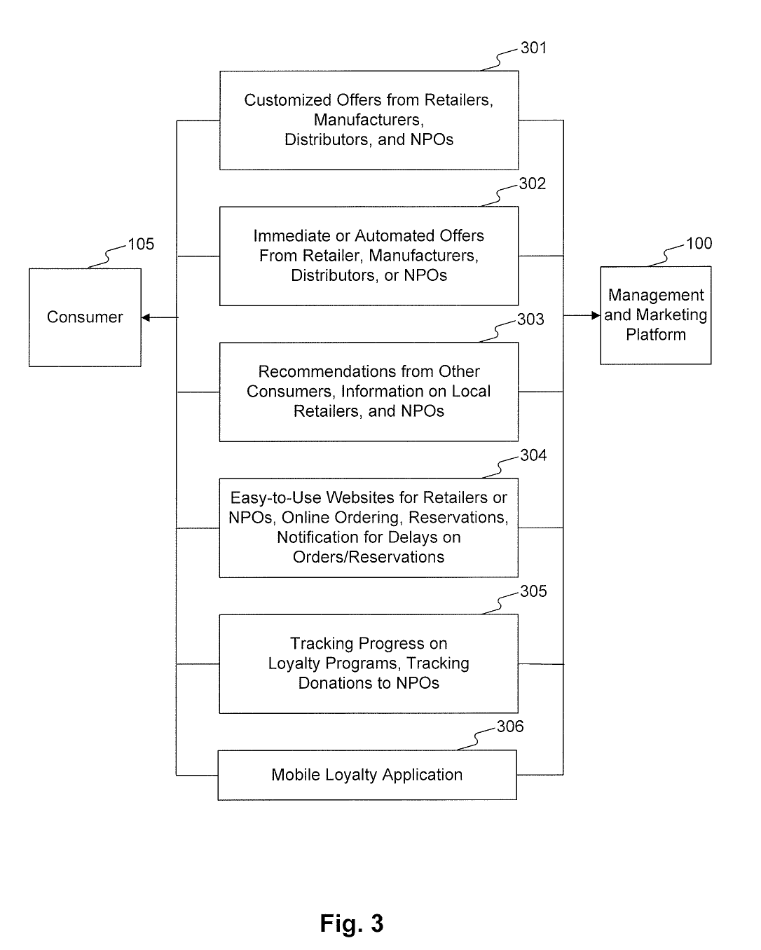

FIG. 3 is a block diagram showing the exchange of information and services between a consumer 105 and the management and marketing platform 100, consistent with embodiments of the present disclosure. One aspect of the system is its ability to give manufacturers 101 (FIG. 1), distributors 102, retailers 103, and NPOs 104 a platform that will help them engage, understand, and build a personal relationship with their customers and non-customer consumers, which may be especially beneficial to small enterprises. It allows them to increase their profitably by building consumer loyalty demand. The integrated database collects data about sales and promotions, and it also collects data provided by the consumers themselves. The system can gather information from consumers passively (e.g., tracking purchases, responses to offers, physical location, point-of-sale monitoring) or actively (e.g., consumer completes a survey, consumer chooses to receive certain offers). The system provides incentives to consumers to actively volunteer information for a variety of reasons: to receive customized offers, recommendations from other consumers, information about the area the consumer is in, etc. For example, a consumer 105 may provide contact information to receive a coupon, or a consumer 105 may provide personal preference information to control the type and frequency of offers pushed to them. The system can also provide consumers with benefits such as online ordering from retailers 103, distributors 102, and manufacturers 101, online reservations, notifications for delays in ordering or delays in seating, and a forum to provide information about their experience with the enterprise to other consumers 105. In some embodiments, the system may provide the consumer 105 with a system webpage where the consumer 105 can directly interact with the system to, among other things, view offers, enter contact information, and add or update preference information. Furthermore, benefits such as online ordering, reservations, and notifications can be made on several different platforms. For example, the ordering can be done on the enterprises' webpage, or the enterprise's Facebook or Twitter page. Consumers 105 can be notified of a delay in seating by tweet or text message. In some embodiments, the marketing and management platform is offered via “the computing cloud.” That is, virtual servers are used to host the marketing and management platform, and the platform is accessible to all entities in the value chain through any web-enabled device. This allows consumers 105 to access proprietors using the media with which they are familiar.

In certain embodiments, the marketing and management platform 100 provides consumers 105 (and other entities in the value chain) with a mobile loyalty application 207. The mobile loyalty application 207 provides consumers 105 an interface with the marketing and management platform via any web-enabled device. The mobile loyalty application 207 may allow users to, among other things, view the provider entities and NPOs participating in the marketing and management platform 100 and opt in to receiving their offers, to enroll in and track progress in the loyalty programs of particular provider entities and NPOs, to enroll in a general loyalty program for all marketing and management platform entities, to receive and respond to surveys sent by the marketing and management platform 100, provider entities, or NPOs, to redeem rewards points or other loyalty points earned through the loyalty programs, to change preferences for receiving offers, etc. The marketing and management platform 100 may also, for example, use the mobile loyalty application, downloaded on an entity's personal web-enabled device, as a proxy for the current geolocation of that entity.

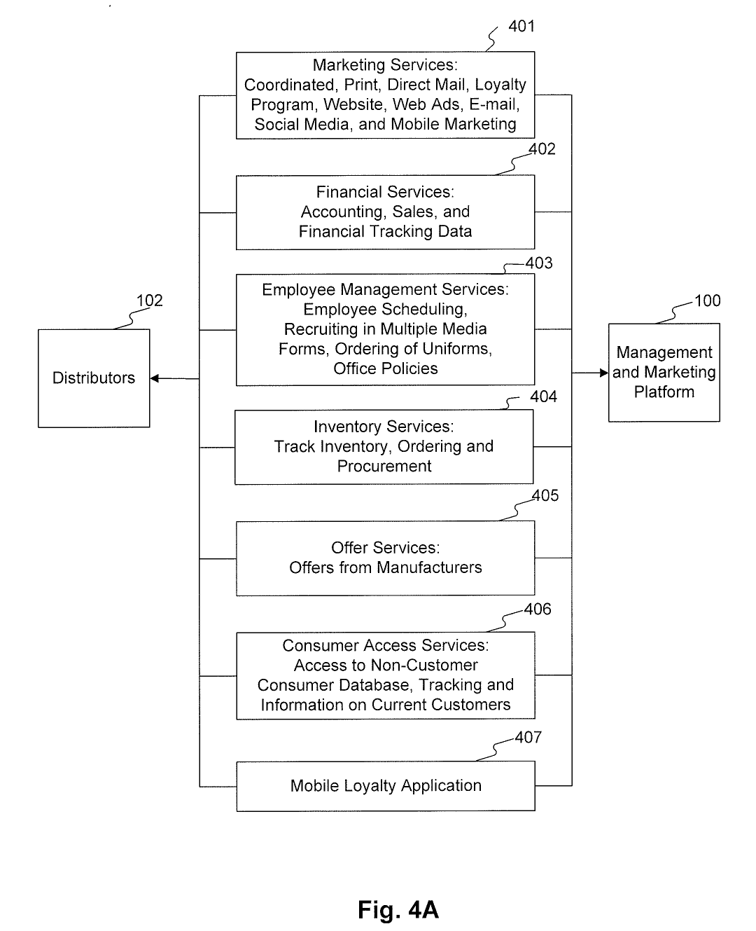

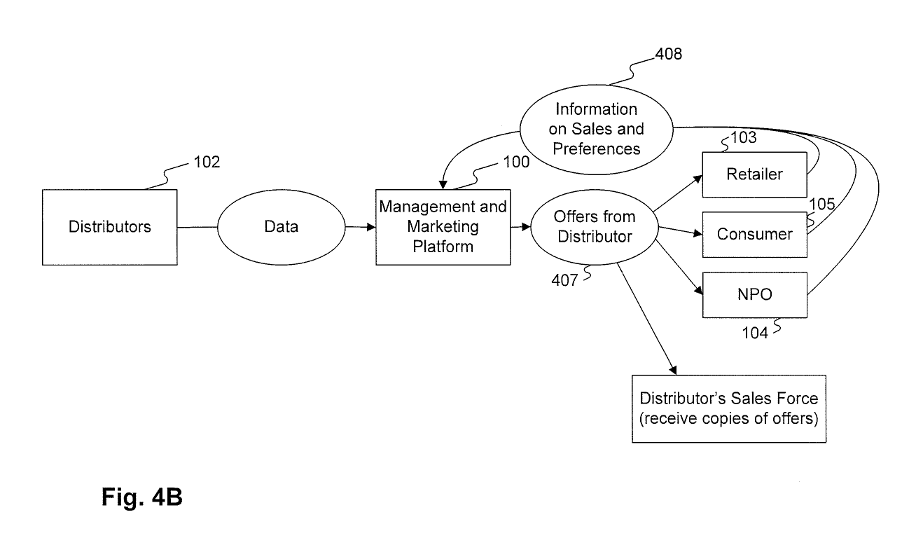

FIGS. 4A and 4B are block diagrams showing the exchange of information and services between distributors 102 and the management and marketing platform 100, consistent with embodiments of the present disclosure.

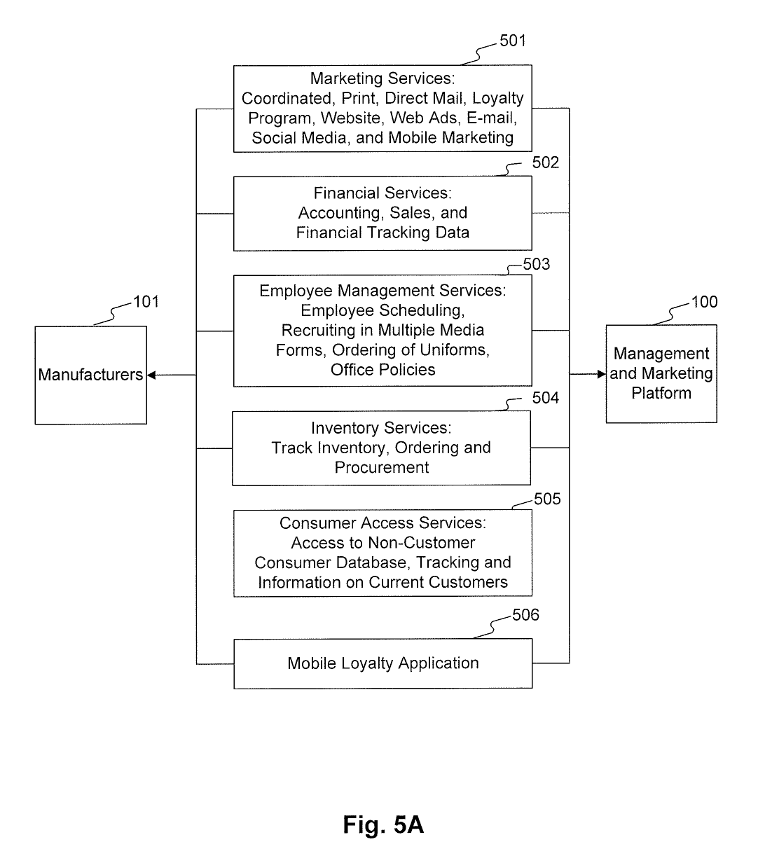

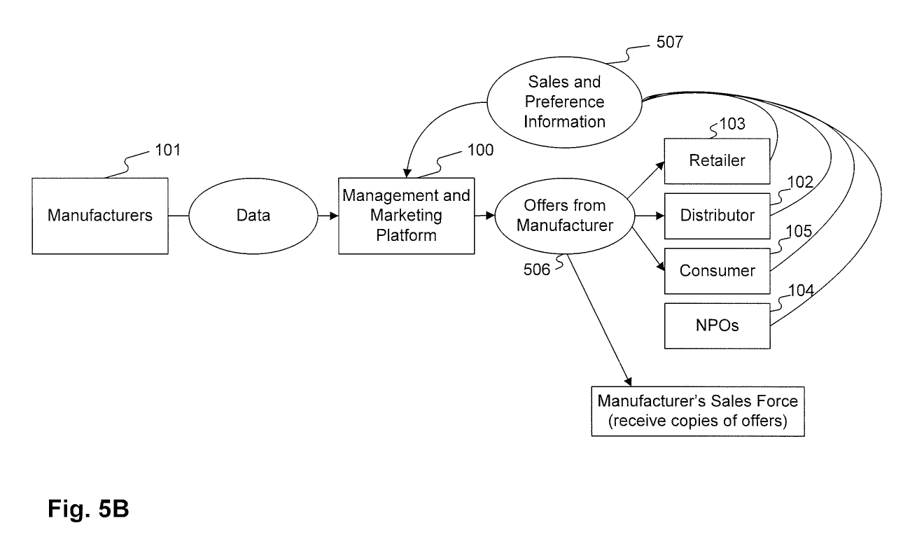

FIGS. 5A and 5B are a block diagrams showing the exchange of information and services between manufacturers 101 and the management and marketing platform 100, consistent with embodiments of the present disclosure. One of skill in the art will understand that the features and uses provided to retailers 103 may similarly be provided to distributors 102 and manufacturers 101. For example, one aspect of the system is the ability of manufacturers 101 and distributors 102 to push offers directly to retailers 103 and consumers 104 without the intervention of a direct sales force (see, e.g., FIG. 4B, offers from distributor 407; and FIG. 5B offers from manufacturer 506). A direct sales force has a high degree of variability which is difficult to monitor. With promotions pushed by the system, response can be easily tracked and reported to the manufacturer and/or distributor (see, e.g., FIG. 4B, information on sales and preferences 408; and FIG. 5B, sales and preference information 507).

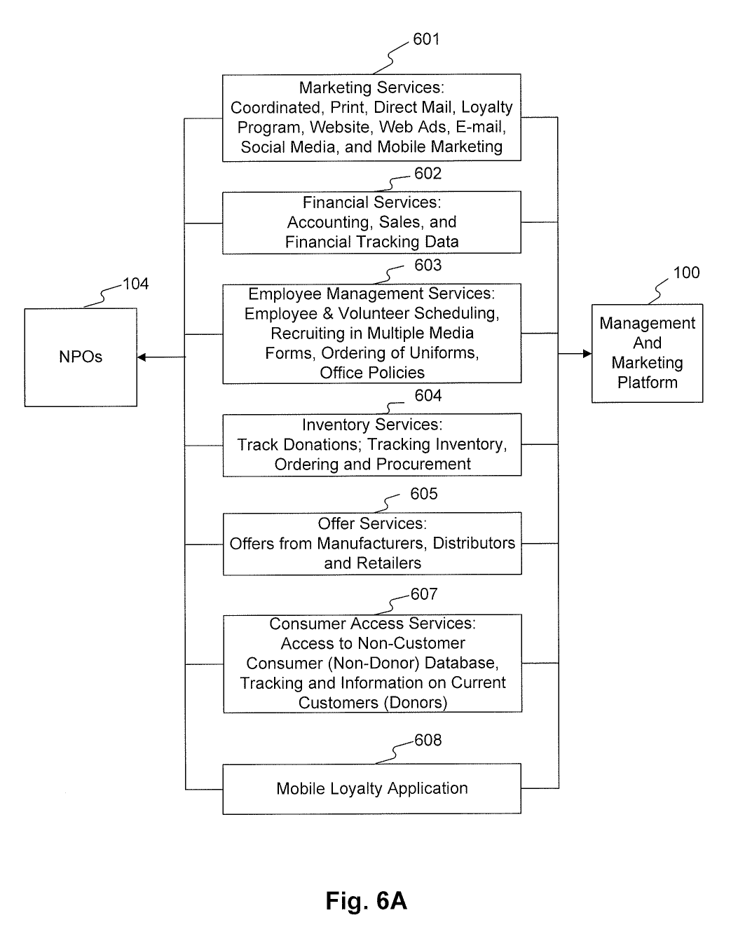

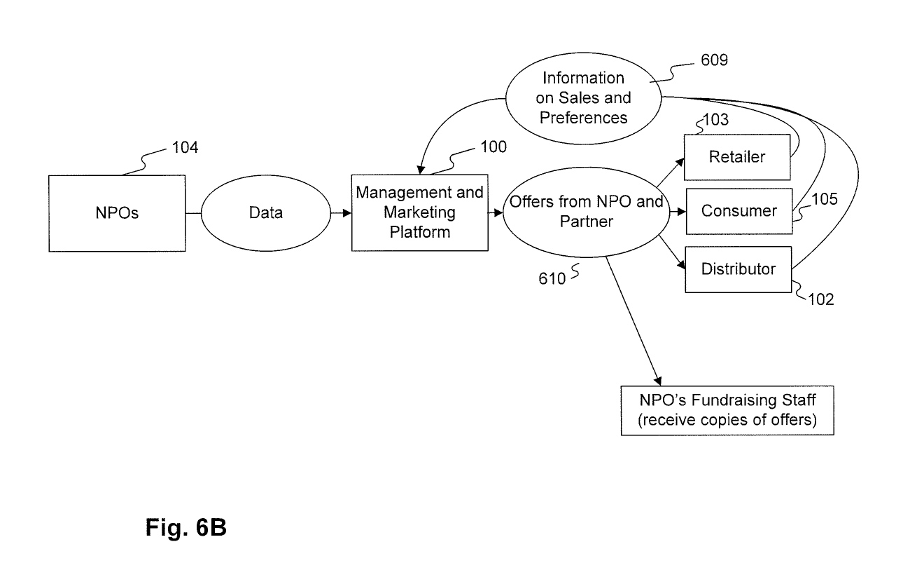

FIGS. 6A and 6B are block diagrams showing the exchange of information and services between NPOs 104 and the management and marketing platform 100. In many ways, some NPOs 104 share many similarities with the for-profit entities in the value chain and NPOs 104 may benefit from many of the same or similar features used by the retailers 103 described above. For example, an NPO 104 may use the consumer access services 607 of the integrated management system to track its donors in a similar manner as a retailer 103 may track its customers. NPOs 104 may also use the marketing services 601 of the integrated management system by partnering with for-profit entities in a value chain to provide offers to consumers 105 to purchase products or services endorsed by the NPO 104. The offer services 605 may be used by the NPO to receive proposals from providers in the value chain to create such partnerships. The marketing services 601 may allow the NPO 104 and the partner to create the marketing for the joint venture and push the offer to both the partner's customers and the NPO's 104 donors. One benefit of using the management and marketing platform 100 to push offers is that the NPO 104 and partner entity do not need to provide each other with direct access their respective donor/customer databases. For example, an NPO 104 and a partnering restaurant may create a fundraising event at the restaurant in which the NPO 104 notifies its donors of a coupon they can purchase entitling them to ½ off a meal at the restaurant. When those individuals purchase the coupon, the donor may then be considered a customer of the restaurant as well, and the restaurant may add that individual to its own database of customers. However, if the donors of the NPO are not interested in the offer and do not purchase the coupon, the donors' contact information is never transferred to the restaurant's database.

One aspect of the system is that the NPO may use the consumer access services 607 as a way to track its donors and access non-donors. That is, with the access to the consumer database, NPOs 104 may push offers directly to its donors and non-donors (customers and non-customer consumers) without requiring a staff of fundraisers. A fundraising staff may be too expensive for an NPO 104. Furthermore, even if an NPO 104 has a fundraising staff, staff members have a high degree of variability which is difficult to monitor. With promotions pushed by the system, response can be easily tracked and reported to the NPO 104, and costs for fundraising can be kept low (see, e.g., FIG. 6B, information on sales and preferences 609).

Furthermore, the management and marketing platform 100 allows the partnering entities access to information on NPOs 104 such as the general location of particular NPO's 104 donors, the success of other campaigns other entities have done with the NPO 104, the causes the NPO 104 supports, the number of donors an NPO 104 has, and a calendar of the NPO's 104 other campaigns, among other things. Thus, a retailer, for example, may use the management and marketing platform to find an NPO with which it would like to partner based on several criteria made available in the management and marketing platform. Similarly, an NPO can also use the management and marketing platform to search for partnering entities based on several criteria such as the number of customers the entity has, the success of other campaigns, the products or services the entity provides, and a calendar of the entity's other campaigns, among other things.

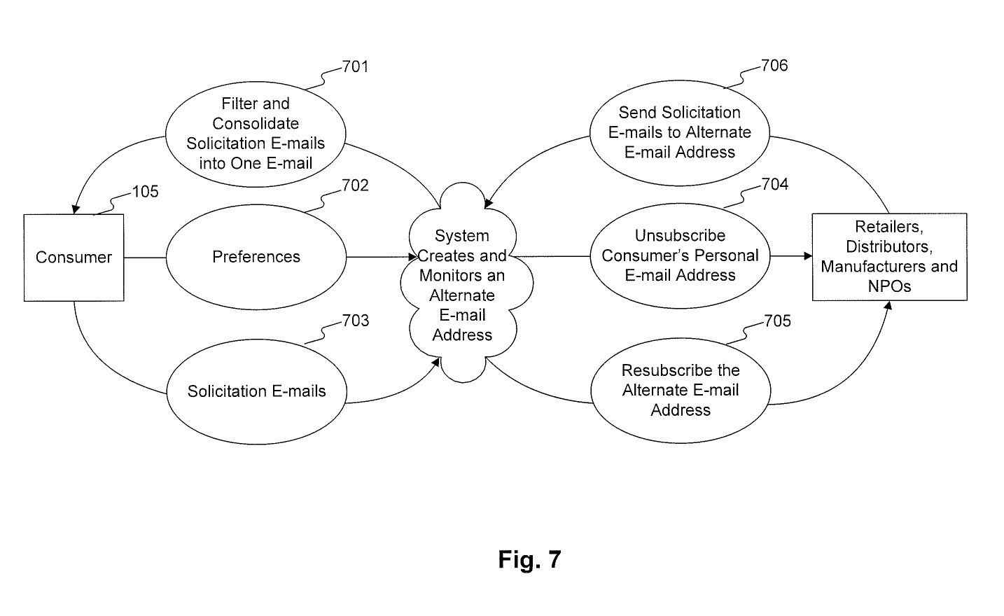

FIG. 7 is a block diagram showing the e-mail consolidation function of the system. The system may provide consolidation of e-mail services 701 to consumers 105, allowing consumers 105 to consolidate multiple e-mail offers, for example, into a single e-mail containing the offers most relevant to them.

The consumer may be receiving solicitation e-mails as a result of his personal e-mail address appearing on solicitation lists of various entities, many of which may be of no interest to the consumer. In certain embodiments, a consumer 105 provides the system with information about his preferences 702 for the offers he wishes to receive. The system then creates an alternate e-mail address for the consumer 105, in the system. The consumer 105 then forwards solicitation e-mails 703 sent to his personal e-mail address by other entities to the alternate e-mail address. The system uses those forwarded solicitation e-mails to unsubscribe the consumer's personal e-mail address 704 from retail offer solicitation lists and re-subscribes to the retail offer solicitations using the system e-mail address 705. The system then receives the solicitation e-mails 706, along with offers from the system's network of businesses, and filters the offers using the consumer's preferences. Finally, the system sends the consumer 105 a consolidated e-mail 701 with the offers that are most consistent with the consumer's preferences. The consolidated e-mails 701 can also be sent to the consumer 105 according to the frequency that the consumer prefers. In this way, the consumer 105 is able to reduce the volume of undesired messages in his personal e-mail while still receiving offers relevant to his preferences. Additionally businesses are able to send deals to a self-selecting audience that is highly likely to take advantage of the promotions, and the system allows them to do so in a way that increases the likelihood that the consumer will see the offer.

Returning to the use of the system by provider entities, in one aspect of the invention, the system may further include an alert function which would allow provider entities to push promotions to sales personnel.

Furthermore, when updates to policies are made, the system allows employers to notify their employees automatically via a variety of methods, including e-mail and text messages. Documents regarding policies and procedures can be electronically uploaded to the system for employees to view. The system can also provide learning centers targeted to each employee's function.

To further increase communication, the system can include personalizable pages for employees, which the employees can then populate with information about themselves. For example, a manufacturer may use the system to provide a sales person with a personal webpage that can be viewed by other sales people, the sales person's customer base of retailers, or anyone the employer or sales person designates. This online presence can foster closer relationships within the sales force and also between the sales people and their customers. A group discussion page can also be included to allow for more informal discussions among the employees and between the employees and their customers.

One aspect of the system is its ability to push offers and collect data in real-time or near real-time. This allows entities to be more responsive to market conditions and individual needs. Manufacturers, distributors, and retailers can better prevent loss due to perishability. For example, if a manufacturer alerts a distributor out that a manufacturer made too much perishable cheese, the distributor could then push an offer directly, and almost instantaneously, to specific consumers who have a history of buying that or a similar product. Consumers can also be provided almost immediate reward for certain behaviors, increasing their loyalty to the other entities in the value chain. For example, a restaurant may give consumers free dessert for providing their cell phone numbers. Using the system, a consumer would be able sign up for the dessert offer while they are eating dinner, and the coupon can automatically be texted to them before they order dessert.

One aspect of the system is its ability to notify a manufacturer's or distributor's sales people and marketing associates of the activities of the retailers that purchase their products. For example, the sales people can be provided with a marketing calendar that displays the deals of its customers (i.e. retailers). The system can also provide the sales people with information on the customers' promotions and notify them of when certain customers have been relatively inactive. Certain financial data about their customers (i.e. about the retailers) may also be provided to the sales people. This allows sales people to become more like marketing advisors and increase their role and relationship with the business enterprises that are their customers.

One aspect of the system is its ability to gather data on consumers and offer demographic information to the other entities in the value chain. This allows the other entities to better predict the success of an offer, thus allowing them to decide whether the cost of having the system push an ad to those consumers is worth the expected returns. The system can also provide offers to consumers in multiple ways, including, but not limited to, direct offers (such as a coupon sent to a consumer), group deals (where the deal is only offered if enough individuals are interested or agree to purchase the offer), sweepstakes (where the winners are selected at random from among the entrants, and contests (where winners are selected by popular vote or judging). Furthermore, consumers seeking deals can use the system to suggest offers to other entities in the value chain. For example, if a consumer is looking for a bar to get a drink every Tuesday night, the consumer might send a suggestion for a drink offer to a local bar owner via the system. Alternatively, the consumer can auction his purchasing power by placing his own offer to the other value chain entities on the system, such as offering to buy a meal if dessert is free. Then many restaurants can respond by giving the consumer a free dessert if he decides to eat a meal at their restaurant or even offering something different. In this way, the system can create a platform for auctioning of purchasing power and negotiation for consumer purchases. In certain embodiments, the system may provide consumers a website for interacting with the system.

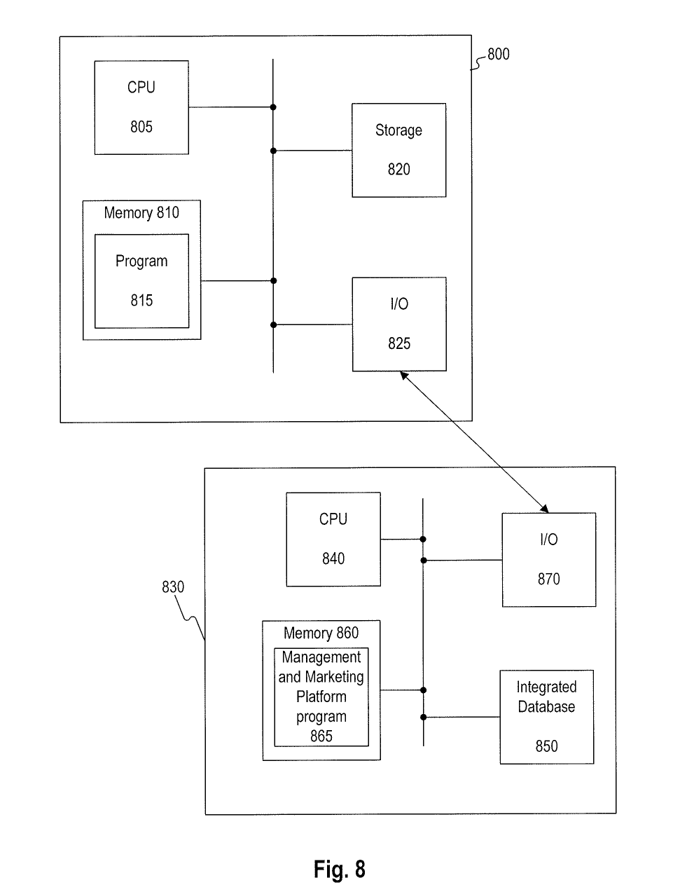

FIG. 8 illustrates an exemplary computing system 800 that may be used to implement embodiments of the disclosure. The components and arrangement, however, may be varied within principles of the present application.

The entities in the value chain access the integrated management system 830 using a data processing or computing system 800, which includes a number of components, such as a central processing unit (CPU) 805, a memory 810, an input/output (I/O) device(s) 825, a nonvolatile storage device 820, and a database 830. System 800 can be implemented in various ways. For example, a personal integrated platform (such as a workstation, personal computer, laptop, Smartphone, etc.) may comprise CPU 805, memory 810, nonvolatile storage 820, and I/O devices 825. In such a configuration, components 805, 810, 820, and 825 may connect through a local bus interface and access the integrated management system 830 (shown implemented as a separate database system) via an external connection. This connection may be implemented through a direct communication link, a local area network (LAN), a wide area network (WAN) and/or other suitable connections.

The integrated management system 830 includes CPU 840, integrated database 850, and memory 860, which stores the management and marketing platform program 865. Management and marketing platform program 865 may incorporate a collection of programs that, when executed, perform functions related to embodiments of the present application.

In some embodiments, the integrated management system 830 may be an embedded system, such that components 805, 810, 820, and 825 may access database 830 through a retrieval library (not shown). In an embedded database embodiment, the system 800 would then be connected to other entities in the value chain via an external connection.

CPU 805 and CPU 840 may be one or more known processing devices, such as a microprocessor from the Pentium™ family manufactured by Intel™ or the Turion™ family manufactured by AMD™. CPU 840 and/or CPU 805 may execute one or more of the programs incorporated in the management and marketing platform program 860. For example, system 800 may access one or more remote programs incorporated in the management and marketing platform program 860 that, when executed, perform functions related to embodiments of the present application.

Memory 810 may be one or more storage devices configured to store information used by CPU 805 to perform certain functions related to embodiments of the present application. Storage 820 may be a volatile or non-volatile, magnetic, semiconductor, tape, optical, removable, non-removable, or other type of storage device or computer-readable medium. In one embodiment consistent with the disclosure, memory 810 includes one or more programs or subprograms 815 loaded from storage 820 or the management and marketing platform program 865 that, when executed by CPU 805, perform various procedures, operations, or processes consistent with the present application.

Memory 860 may be one or more storage devices configured to store information used by CPU 840 to perform certain functions related to embodiments of the present application. Integrated database 850 may be a volatile or non-volatile, magnetic, semiconductor, tape, optical, removable, non-removable, or other type of storage device or computer-readable medium. In one embodiment consistent with the disclosure, memory 860 includes one or more programs or subprograms loaded from the management and marketing platform program 865 loaded from integrated database 850 that, when executed by CPU 840, perform various procedures, operations, or processes consistent with the present application.

Methods, systems, and articles of manufacturer consistent with the present application are not limited to personal integrated platforms configured to access one or more remote programs in a remote integrated management system. For example, memory 810 may include various exemplary components included in the management and marketing platform 100, such as certain employee management services 203. These components may also be embodied in a computer-readable storage memory containing instructions that, when executed by a processor, such as CPU 805, perform methods as described above.

Memory 810 or memory 860 may be also be configured with operating systems (not shown) that perform several functions well-known in the art when executed by CPU 705. By way of example, the operating system may be Microsoft Windows™, Unix™, Linux™, Mac OS X™, Personal Digital Assistant operating system such as Microsoft CE™, or other operating system. The choice of operating system, and even the use of an operating system, is not critical to the disclosure.

I/O device(s) 825 and I/O device(s) 870 may comprise one or more input/output devices that allow data to be received and/or transmitted by systems 800 and 830, respectively. For example, I/O device 825 may include one or more input devices, such as a keyboard, touch screen, mouse, and the like, that enable data to be input from a value chain entity. Further, I/O device 825 and I/O device 870 may include one or more output devices, such as a display screen, CRT monitor, LCD monitor, plasma display, printer, speaker devices, and the like, that enable data to be output or presented to a value chain entity. I/O device 825 may also include one or more digital and/or analog communication input/output devices that allow computing system 800 to communicate with other machines and devices, such as integrated management system 830. System 800 may input data from external machines and devices and output data to external machines and devices via I/O device 825, for example, when communicating with integrated management system 830. In one embodiment, I/O device 825 may include an interface (not shown) to receive inputs from entities in the value chain. Similarly, I/O device 870 may also include one or more digital and/or analog communication input/output devices that allow integrated management system 830 to communicate with other machines and devices, such as computing system 800. Integrated management system 830 may input data from external machines and devices and output data to external machines and devices via I/O device 825, for example, when communicating with computer system 800. The configuration and number of input and/or output devices incorporated in I/O device 825 and 870 are not critical to the disclosure.

System 800 may also be communicatively connected to database 850. Database 850 may comprise one or more databases that store information and are accessed and/or managed through system 800. By way of example, database 850 may be implemented using software such as Oracle™ database, Sybase™ database, DB2 database, or other relational database. Database 850 may include, for example, one or more repositories that store inputs received by computer system 800. As noted above, however, systems and methods of the present application are not limited to separate databases in a separate integrated management system.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

We claim:

1. A method for processing management data, comprising:
receiving, via a portal, a request to access a management computer system;
receiving a selection of a first management function;
receiving information related to the first management function; and
automatically updating at least one second management function associated with the first management function.

2. The method of claim 1, the first management function being selected from the group consisting of: marketing services, financial services, employee management services, inventory services, offer services, and consumer access services.

3. The method of claim 2, wherein:
the first management function comprises marketing services; and
the method further comprises sending an offer to at least one entity in a value chain.

4. The method of claim 3, wherein the entity in the value chain is a consumer, provider, or non-profit organization (NPO).

5. The method of claim 4, wherein the offer is targeted to the entity.

6. The method of claim 2, wherein:
the first management function comprises consumer access services; and
the method further comprises providing a purchase history of at least one consumer.

7. The method of claim 2, wherein:
the first management function comprises marketing services; and
the method further comprises analyzing the effectiveness of an offer.

8. A management computer system comprising:
a memory containing instructions;
and a processor coupled to the memory and executing the instruction to:
receive a request, via a portal, to access the system;
receive a selection of a first management function;
receive information related to the first management function; and
automatically update at least one second management function associated with the first management function.

9. The system of claim 8, the first management function being selected from the group consisting of: marketing services, financial services, employee management services, inventory services, offer services, and consumer access services.

10. The system of claim 9, wherein:
the selected management function comprises marketing services; and
the processor further executing the instructions to:
receive a request to send an offer to at least one entity in a value chain; and
send a request to at least one entity in a value chain.

11. The method of claim 10, wherein the entity in the value chain is a consumer, provider, or non-profit organization (NPO).

12. The method of claim 11, wherein the offer is targeted to the entity.

13. A method for sharing information among entities of a value chain, comprising:
receiving information from the entities;
storing the information in an integrated database; and
transmitting the stored information to the entities according to a rules engine.

14. The method of claim 13, wherein the information transmitted comprises a purchasing history of at least one consumer.

15. The method of claim 13, wherein the information transmitted comprises an offer.

16. The method of claim 13, wherein the information transmitted comprises an analysis of the effectiveness of an offer.

17. A method for providing an e-mail message consolidation service, comprising:
receiving information on a preferences of a consumer;
creating an alternate e-mail address for the consumer;
receiving, at the alternate e-mail address, from the consumer, at least one solicitation e-mail message received by the consumer from an entity having a list including the consumer's personal e-mail address;
unsubscribing the consumer's personal e-mail address from the list;
re-subscribing the consumer's alternate e-mail address to the list;
receiving at least one solicitation e-mail sent to the consumer at the alternate e-mail address;
filtering the at least one solicitation e-mail received at the alternate e-mail address according to the consumer's preferences; and
sending a consolidated e-mail message comprising at least one solicitation from the filtered solicitation e-mail messages to the consumer's personal e-mail address.

18. The method of claim 17, wherein the consolidated e-mail message includes at least one solicitation from sources other than the at least one solicitation e-mail message.

19. The method of claim 17, wherein the at least one solicitation from sources other than the at least one solicitation e-mail message are filtered according to the consumer's preferences.
